(19) United States
(12) Patent Application Publication
(10) Pub. No.: US 2014/0304701 A1
(43) Pub. Date: Oct. 9, 2014

(54) Object-Oriented Open Framework for Campaign Generation

(71) Applicant: TELEFONAKTIEBOLAGET L M ERICSSON (PUBL), Stockholm (SE)

(72) Inventor: Huiping ZHANG, Brossard (CA)

(73) Assignee: Telefonaktiebolaget L M Ericsson (Publ), Stockholm (SE)

(21) Appl. No.: 13/856,665

(22) Filed: Apr. 4, 2013

(51) Int. Cl. G06F 9/445; G06F 9/44

(52) U.S. Cl. CPC G06F 8/61; G06F 8/70
USPC 717/174

(57) ABSTRACT

A campaign generation framework is provided for generating a campaign file that describes actions for installing a software bundle on a highly available system. A campaign initialization procedure compliant with the Software Management Framework (SMF) is automatically generated based on a configuration file and an Entity Types File (ETF). The configuration file describes a deployment configuration of the highly available system, and the ETF describes the software bundle. The SMF defines Extensible Markup Language (XML) schemas that include XML elements organized as a hierarchy. A hierarchy of entities types is constructed for the deployment configuration from top to bottom of the hierarchy using the campaign generation framework that includes a set of object-oriented classes and methods provided by the classes. Each XML element in the XML schemas corresponds to one of the classes, and the classes are grouped into module classes according to the hierarchy of the XML elements.

### TECHNICAL FIELD

Embodiments of the invention relate to software management; and more specifically, to management of campaign generation.

### BACKGROUND

The Service Availability Forum (SA Forum or “SAF”) is a consortium of industry-leading companies promoting a set of open specifications that enables the creation and deployment of highly available and mission critical services. As a standardization body, the SA Forum has defined a set of open specifications, including the Software Management Framework (SMF) and the Availability Management Framework (AMF), for middleware services. The SMF is defined to support software upgrade in a SA Forum compliant system. The AMF is defined to maintain and manage high availability of the services provided by applications.

An SA Forum compliant system can be characterized by its deployment configuration. The SMF orchestrates the installation and migration of the deployment configuration while ensuring service availability. In SMF terminology, a campaign is a script file that identifies the installation methods, as well as the target system where a software bundle is to be installed. The campaign also specifies how the components defined in software bundle are to be managed at runtime through the AMF. The campaign is executed by the middleware that implements the SMF. A campaign typically uses an XML schema compliant with the SMF specification.

A campaign is not only used for installation, but also applicable for upgrading and removing software. Upgrading and removing campaigns are typically built online, using runtime configuration of the target system.

Conventional tools for generating a campaign generally require a deep knowledge of the SMF and AMF concepts. Such tools are difficult to use for automation of the installation process. Most of the existing software providers manually create the campaign files. Manual creation of the campaign files is error-prone and inflexible, and the created files are hard to maintain due to the complexity, such as in a complicated cluster deployment scenario. In most cases, middleware or application designer groups develop their own scripts for generating the campaign files. Usually, the pre-created campaigns are apt only for testing environments or a few pre-defined deployment scenarios. These pre-created campaigns cannot be easily adapted to complicated multi-clusters, multi-applications deployments.

### SUMMARY

Embodiments of the invention provide a method and system for generating a campaign file that describes actions for installing a software bundle on a highly available system. In one embodiment, the method comprises a computer system receiving a configuration file that describes a deployment configuration of the highly available system, and receiving an entity types file (ETF) that describes the software bundle. The method further comprises the computer system automatically generating a campaign initialization procedure compliant with a Software Management Framework (SMF) based on the configuration file and the ETF. The SMF defines Extensible Markup Language (XML) schemas that include XML elements organized as a hierarchy. When automatically generating the campaign initialization procedure, the computer system constructs the hierarchy of entities types for the deployment configuration from top to bottom of the hierarchy using a campaign generation framework that includes a set of object-oriented classes and methods provided by the classes. Each XML element in the XML schemas corresponds to one of the classes, and the classes are grouped into module classes according to the hierarchy of the XML elements. The method further comprises outputting the campaign file that includes the campaign initialization procedure.

In another embodiment, a computer system is adapted to generate a campaign file that describes actions for installing a software bundle on a highly available system. The computer system comprises one or more processors, one or more memory devices coupled to the one or more processors, and a campaign generator coupled to the one or more processors and the one or more memory devices. The campaign generator using the campaign generation framework is adapted to perform the method described above.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

FIG. 1A illustrates an example of a class diagram hierarchy according to the Upgrade Campaign Specification (UCS) schema for campaign generation according to one embodiment of the invention.

FIG. 1B illustrates an example of another class diagram hierarchy according to the Entity Types File (ETF) schema for campaign generation according to one embodiment of the invention.

FIG. 2A illustrates an example of top-level campaign building classes and their containment relationship, according to one embodiment of the invention.

FIG. 2B illustrates an example of the containment relationship among the ETF top-level classes according to one embodiment.

FIG. 3 illustrates an example code segment of a configuration file according to one embodiment of the invention.

FIG. 4 illustrates a flow diagram for a campaign generation process according to one embodiment of the invention.

FIG. 5 illustrates a flow diagram for constructing an entity type according to one embodiment of the invention.

FIG. 6A is a flow diagram of a method for an installation operation performed on a target system according to one embodiment of the invention.

FIG. 6B is a flow diagram of a method for a remove operation performed on a target system according to one embodiment of the invention.

FIG. 7 illustrates a flow diagram of a method for campaign generation according to one embodiment of the invention.

FIG. 8 illustrates an exemplary computer system according to one embodiment of the invention.

### DESCRIPTION OF EMBODIMENTS

In the following description, numerous specific details are set forth. However, it is understood that embodiments of the invention may be practiced without these specific details. In other instances, well-known circuits, structures and techniques have not been shown in detail in order not to obscure the understanding of this description. It will be appreciated, however, by one skilled in the art, that the invention may be practiced without such specific details. Those of ordinary skill in the art, with the included descriptions, will be able to implement appropriate functionality without undue experimentation.

Embodiments of the invention provide a light-weight campaign generation framework (the “framework”) that enables automated software installation, upgrade and removing processes. The framework enables software providers to provide a ready-to-be-used campaign generator for field engineers to generate installation campaigns on target systems locally or remotely. In one embodiment, the campaign generator is a script built on top the framework and is adapted to different deployment scenarios. Using the script, campaigns can be generated either offline or online (i.e., during live system operations). The online generation is useful for software upgrade and removing operations, as the campaigns are tightly dependent on existing deployment configuration.

The framework can be run on a wide range of operating system platforms; e.g., Linux® Windows®, Unix®, Mac OS X®, etc. In one embodiment, the framework is written in a scripting language; e.g., an object-oriented scripting language, such that it can be run without being re-compiled. The framework can be easily debugged and can adapt to a real system's software deployment requirements. The framework needs minimum deployment runtime configuration.

In one embodiment, the framework is based on the Python programming language. Python is an interpreted, interactive, object-oriented, extensible scripting programming language, which is an easy but powerful scripting programming language. It is run through a Python interpreter, which is available for all major operating system platforms. Although the use of Python is described below, it is appreciated that alternative object-oriented programming languages may also be used.

The framework enables the automatic generation of campaign files that are compliant with the SMF Upgrade Campaign Specification (UCS) and Entity Types File (ETF). Each of UCS and ETF defines an Extensible Markup Language (XML) schema. The framework maps the XML elements and attributes defined by the UCS and ETF to Python classes and class attributes, and produces XML formatting for all elements and attributes. The classes are grouped as Python modules following the XML schemas. The framework can be installed as a common library on an operating system platform. Field engineers can import the framework on a target system, and execute the campaign generation script on the target system by supplying minimum runtime configuration information. As the framework is built using open technology and is compliant with open standards, it can be used as an open source framework for any SAF compliant systems.

The framework is open and extensible. Application providers and designers can build provider-specific entities on top of the framework. The extended layers of the framework can be shared and re-used by others. The framework is also easy to maintain. Changes in a deployment configuration can be easily made on the target system without code recompilation. With the framework, software providers' work can be separated from software deployments' work. The framework enables the construction of integrated campaigns for installing, upgrading and removing different software providers' released bundles on a target system.

In the software subsystem described herein, the basic building block of a configuration is a component. A component is an entity that abstracts a set of software/hardware resources. Components can be deployed on nodes. The nodes provide an execution environment for the components and include virtual machines and hardware such as e.g., processors, computers, or other processing hardware. The service(s) provided by the component is represented by a component service instance (CSI). Each CSI represents a unit of workload. Components that closely collaborate and that must be collocated to provide an integrated service are grouped into a service unit (SU). Service Instance (SI) is the aggregation of the workloads of the components contained in an SU. A set of redundant SUs that collaborate to provide and protect a set of services form a service group (SG). Services are provided by SUs and protected against failures within a SG. An application is a set of SGs. These different entities identify different increasing fault zones, which are the scopes that can be isolated and repaired to isolate a fault.

An ETF describes the software resources provided by a software vendor to the software subsystem. An ETF contains a collection of entity prototypes, which specify characteristics of the entities as well as the entities' capabilities and limitations. Moreover, the entity prototypes describe how the software entities can be combined by providing information regarding their dependencies and compatibility options. From the entity prototypes a number of different entity types can be derived. Each entity type can be instantiated as one or more entities. Examples of entity types include application type (AppType), SG type (SGType), SU type (SUType), component type (CompType), etc.

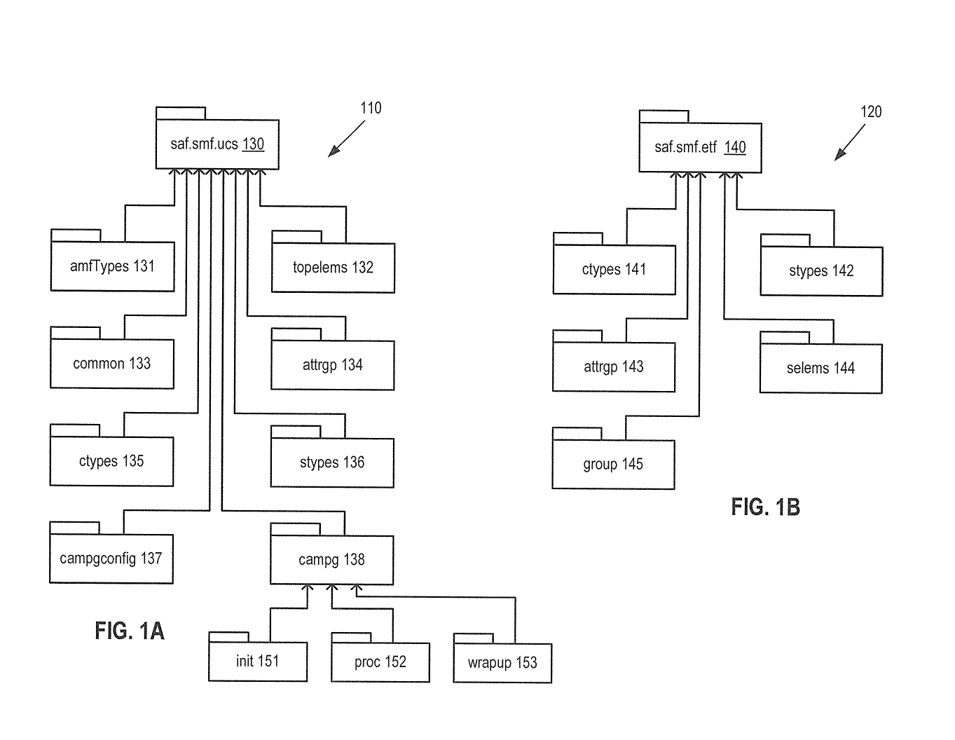

FIG. 1A is an example of a class diagram illustrating a hierarchy of module classes supported by the framework according to one embodiment. The class diagram includes top-level Python classes that are grouped into a set of UCS module classes 110. A module class is a group of classes. At the top level of the hierarchy is the module class saf.smf.ucs 130, which has a group of module classes as its sub-classes; e.g., AMF types (amftypes 131), top elements (topelems 132), common types (common 133), attribute groups (attrgp 134), complex types (ctypes 135), simple types (stypes 136), campaign configuration (campconfig 137) and campaign generator (campg 138), etc. In an alternative embodiment, more module classes may be included, or some of the module classes may be combined. Each of these module classes may have a group of classes or a group module classes as its sub-classes. For example, the module class campg 138 has a group of module classes as its sub-classes: init 151, proc 152 and wrapup 153. The hierarchy of the UCS module classes 110 is constructed according to the same hierarchy of XML elements in the UCS XML schema. That is, the UCS module classes 110 implement the UCS XML schema. Each XML element in the UCS XML schema corresponds to one of the classes in the UCS module classes 110. In one embodiment, the UCS module classes 110 and their corresponding XML elements of the UCS XML schema are named the same names.

FIG. 1B is an example of another class diagram illustrating a hierarchy of module classes supported by the framework according to one embodiment. The class diagram includes top-level Python classes that are grouped into a set of ETF module classes 120. At the top level of the hierarchy is the module class saf.smf.etf 140, which contains a group of module classes; e.g., complex types (ctypes 141), simple types (stypes 142), attribute groups (attrgp 143), selems 144 and group 145, etc. In an alternative embodiment, more module classes may be included, or some of the module classes may be combined. The hierarchy of the ETF module classes 120 is constructed according to the same hierarchy of XML elements in the ETF XML schema. That is, the ETF module classes 120 implement the ETF XML schema. Each XML element in the ETF XML schema corresponds to one of the classes in the ETF module classes 120. In one embodiment, the ETF module classes 120 and their corresponding XML elements of the ETF XML schema are named the same names.

For simplicity of the description, attributes and lower level classes are not shown in FIG. 1A and FIG. 1B. However, it is appreciated that all elements and attributes from the UCS XML schema and ETF XML schema are mapped into classes and attributes in the framework.

In one embodiment, the module class amftypes 131 includes the classes AppBaseType, CompBaseType, ServiceBaseType, SGBaseType, CSBaseType and SUBaseType. The module class topelems 132 includes the classes AtAction, Attribute, Callback, CmdArgv, ImmCCB, PlmExecEnv and UpgradeCampaign. The module class common 133 includes the classes CampaignXmlElement and CampaignLogger. The module class attrgp 134 includes the classes AdminOperation, CompCapability and HealthCheck. The module class ctypes 135 includes the classes ActionCountT, ActionT, ActivationUnitPairT, AdminOperatoinT, BundleRef, CallbackOptionsT, CliParametersT, EntityListT, EntityTemplateT, ImmCreateT, ImmDeleteT, ImmModify, ImmObjectT, StepCountT and ImmModifyT. The module class stypes 135 includes the classes AdminOperationIdT, ModifyOperationT, SaAmfAdminOperationIdT, SaImmValueTypeT, SaPlmAdminOperationIdT, SaClmAdminOperationIdT, SaSmfAdminOperationIdT, SaUint32T, SaTimeT, SaUint32T, SaStringT and SaNameT. Under the class SaStringT includes SaCmpgNameT and SaProcNameT. Under the class SaNameT includes AppTypeNameT, SaAmfNodeNameT, SaClmNodeNameT, CompTypeNameT, SrvTypeNameT, SadwBundleNameT, SuTypeNameT, CSTypeNameT, SaSiNameT, SGTypeNameT and SaPlmEeNameT. The module class campgconfig 137 includes the classes AmfSGConfig, InstallCampaignConfig, NodeGroupConfig, SwBundleConfig and UpgradeProcConfig. The module class campg 138 includes the classes CampaignInfo, CampaignInitialiation, CampaignWrapup, UpgradeMethod and UpgradeProcedure. The module class init 151 includes the classes AddToImm, Offline, Online, AmfEntityTypes, SoftwareBundle and CampInitAction. The module class proc 152 includes the classes AcceptableServiceOutage, OutageInfo, ProcedurePeriod, RollingUpgrade, SingleStepUpgrade and TargetEntityTemplate. The module class wrapup 153 includes the classes RemoveFromImm, WaitToAllowNewCampaign and WaitToCommit. In an alternative embodiment, more classes may be included, or some of the classes may be combined.

In one embodiment, the module class etf (i.e., saf.smf.etf 140) includes the classes AmfEntityType, EntityTypesFile, EtfAppType, EtfCompType, EtfCSType, EtfCSType, EtfServiceType, EtfServiceType, EtfServiceType, EtfSGType, EtfSUType and EtfSwBundle. The module class ctypes 141 includes the classes BoundedTimeT, BoundedTimeT, ProbabtionT and UnsignedIn32T. The module class stypes 142 includes the classes SaStringT, EtfSaTimeT, RedModelT, HealthcheckVariantT and RecommendedRecoveryT. Under the class SaStringT includes AppTypeNameT, CSTypeNameT, CompTypeNameT, VersionT, SGTypeNameT, SrvTypeNameT, SwBundleNameT and SuTypeNameT. The module class attrgp 143 includes the classes CompType, CsType and ValueRange. The module class selems 144 includes the classes EtfHealthCheck, InstantiateCmd, NumInstances, NumMaxActiveCsi, NumMaxStandbyCsi and QuiescingComplete. The module class group 145 includes the classes CliParameters, CommonCompAttributes, CompCallbackTimeouts, EtfCompCapability and ScopeOfImpact. In an alternative embodiment, more classes may be included, or some of the classes may be combined.

In one embodiment, the module classes and classes are defined following the XML schema (including the UCS XML schema and ETF XML schema) naming convention. All of the XML schema elements are defined as classes using the same names. Each of these classes takes its required attributes as input and is responsible to build an object for its corresponding XML element. For campaign generation, the top class is a class Campaign, which is the entry class for retrieving top campaign elements. In one embodiment, the class Campaign is under one of the UCS module classes 110 in FIG. 1A; e.g., a module class xml (not shown in FIG. 1A).

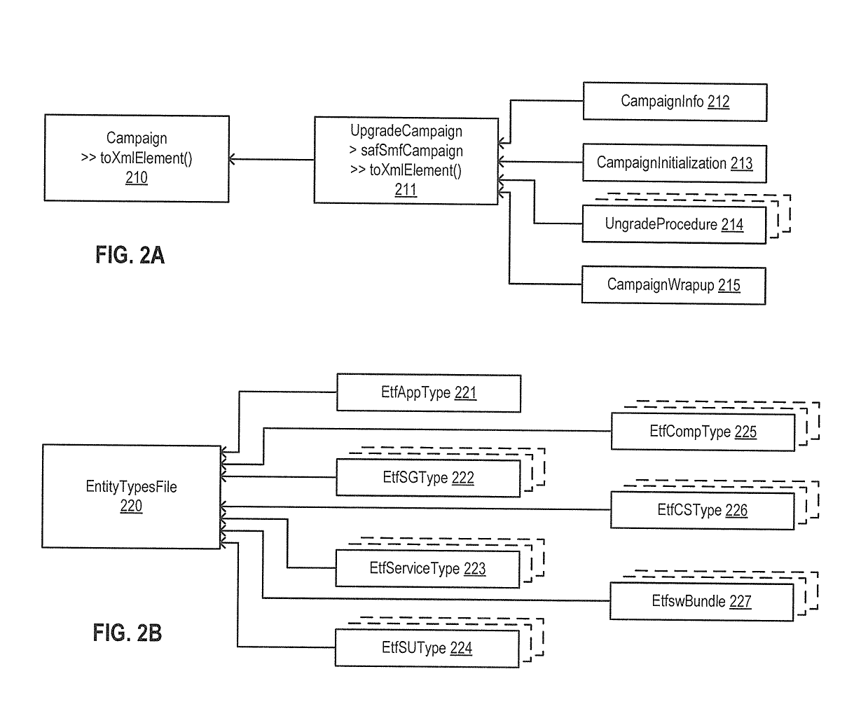

FIG. 2A illustrates an example of top-level campaign building classes and their containment relationship, according to one embodiment. The lower-level classes are not shown. The class Campaign 210 contains the top UCS schema element mapping class UpgradeCampaign 211 as a sub-class (i.e., child class), starting from which all campaign elements can be built and retrieved. Under the class UpgradeCampaign 211 are the sub-classes CampaignInfo 212, CampaignInitialization 213, UpgradeProcedure 214 and CampaignWrapup 215. A parent class invokes the XML element building process in all of its sub-classes (i.e., children classes) to construct children XML element objects for the campaign file. These children XML element objects are attached to the parent XML element object (which is constructed by the parent class), in such a way that all of the children XML element objects and their children XML element objects are retrievable from the top XML element object. As each XML element object directly mapped to a corresponding XML element, the terms “XML element object” and “XML element” are used interchangeably herein.

For supporting the process of constructing XML elements for the campaign file, each class implements the class CamapignXmlElement abstract methods “toXmlElement” if the class represents a schema element, and “toXmlAttribute” if the class represents the schema's attribute. These methods provide a unified mechanism for the campaign generator to generate the XML elements for the classes. The class CamapignXmlElement defines also the method getPrettyXML( ) which is invoked at the end of the campaign generation to produce a finalized XML file (i.e., the campaign file) containing all XML elements previously built.

FIG. 2B illustrates an example of the containment relationship among the ETF top-level classes according to one embodiment. The framework provides an ETF file parser. The class represents the ETF file is an EntityTypesFile class 220, which is under the module class etf 140. The class 220 takes an ETF file as input, parses the file, and keeps all of the parsed AMF entity types and software bundles objects. The parsing is performed recursively per entity type. The references of contained elements are kept in the parent class. For example, the top class EntityTypesFile 220 keeps the references to its top contained classes, which include EtfAppType 221, EtfSGType 222, EtfServiceType 223, EtfSUType 224, EtfCompType 225, EtfCSType 226 and EtfswBundle 227, etc. The lower-level classes are not shown. The framework also provides a campaign configuration parser. The parsing of the campaign configuration file is implemented in a class InstallCampaignConfig (not shown).

The framework significantly simplifies the campaign generation process. The framework enables a field engineer to perform offline campaign generation (for initial installation) and online campaign generation (for upgrade or removal) with minimum knowledge of complex AMF and SMF models. The automated generation process reduces human errors and system downtimes. Based on the basic classes provided by the framework, software providers can pre-define their specific campaign entities for building the campaign generation scripts.

In one embodiment, the campaign generator includes an installation campaign generator for generating an installation campaign. The installation campaign describes the actions for installing software on a target system. The installation campaign generator receives on or more ETFs (e.g., an ETF.xml file) as input. The ETF provides a static description of the software bundles to be installed by the campaign, as well as a description of the software AMF static deployment model. In one embodiment, the ETF defines the base types of AMF entities such as SG, SU, components, etc., and the mapping and grouping of SU, SG, components, etc. The ETF also provides the redundancy model of the SG. This ETF is released with the software, and should not be changed by field engineer.

In one embodiment, application designers who have the knowledge of the AMF and the SMF can build command line scripts using the framework for supporting the campaign generations operations. The task of the application designers is performed offline, and is one-time work. The application designers can also prepare templates files for ETFs and configuration files. In one embodiment, the framework can be extended to generate the ETF. Generating the ETF file requires a simple software configuration file, which describes the software bundles, redundancy model and services information.

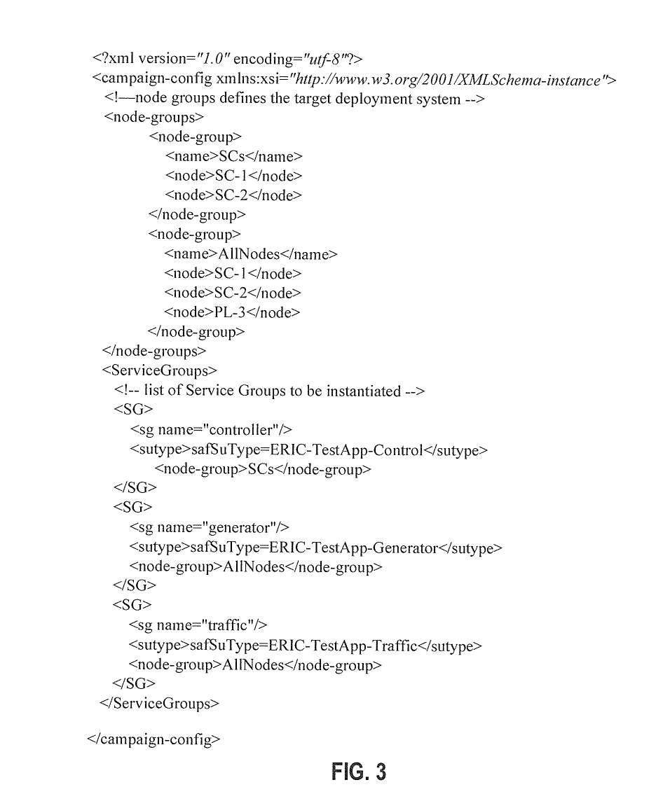

The configuration file is provided by the field engineer to describe the target system configuration. The configuration file provides minimum runtime deployment information. FIG. 3 illustrates one example of the configuration file according to one embodiment. The configuration file provides information such as the node group on which the software will be installed, service group information to be created, the number of software bundle instances (e.g., software processes such as HTTPD servers) to be started.

Based on the ETF and the configuration file, the campaign generator generates a campaign file. A campaign configurator according to the campaign file creates instances of AMF entities such as SU, SG, SI, CSI instances on the target system, and thereby installs the software bundle on the target system.

After the initial installation, software can be upgraded using an upgrade campaign. Only runtime configuration is needed for generating the upgrade campaign. Software can also be removed through a remove campaign. The remove campaign is generated based on runtime deployment information; no external configuration is necessary. The framework can be used for generating the campaigns for all of the above-described use cases.

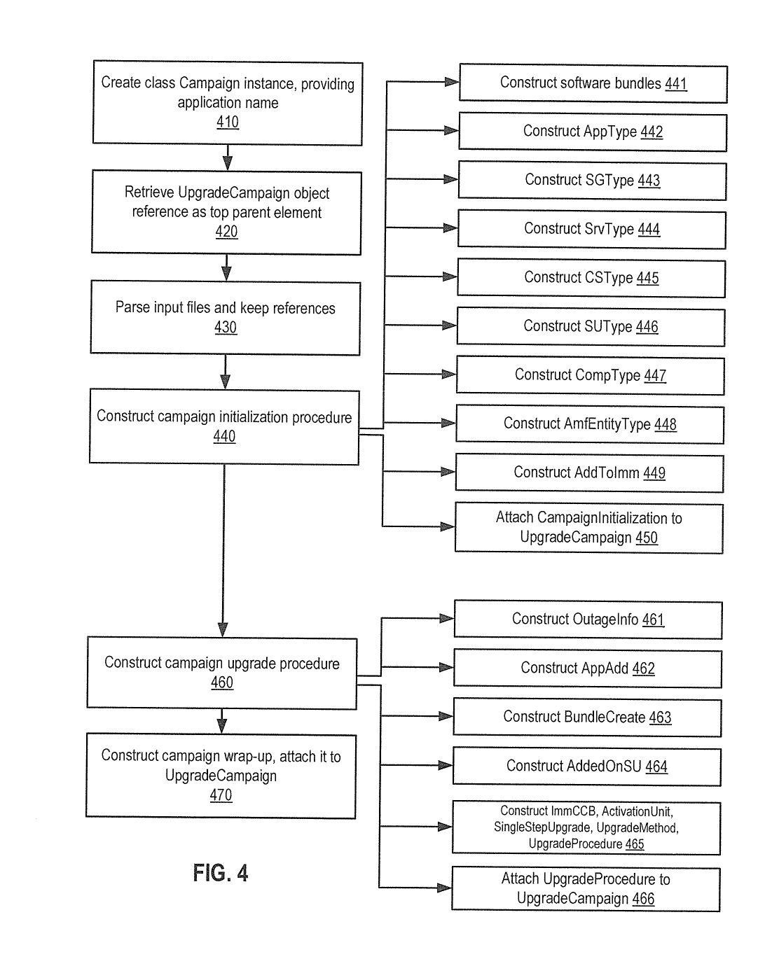

FIG. 4 illustrates an example of a campaign generation process performed by a campaign generator using the classes provided by the framework, according to one embodiment. The campaign generator includes an installation campaign generator and a remove campaign generator. In one embodiment, the campaign generator is software prepared by an application developer and released with the software bundle, which contains the application to be installed on the target system. The campaign generator receives the ETF file and the configuration file as input. The campaign generator starts with creating a Campaign class instance, providing the application name (block 410). The campaign generator retrieves the UpgradeCampaign object reference as the top parent element (block 420), parses the input files (i.e., the ETF file and the configuration file) and keeps references to the parsed elements (block 430). Then the campaign generator constructs a campaign initialization procedure (block 440), a campaign upgrade procedure (block 460), and a campaign wrap-up procedure at the end (block 470), attaching the campaign wrap-up procedure to the UpgradeCampaign. When constructing the campaign initialization procedure at block 440, the campaign generator constructs the following: software bundles (block 441), AppType (block 442), SGType (block 443), Sry (block 444), CSType (block 445), SUType (block 446), CompType (block 447), AmfEntityType (block 448) and AddToImm (block 449). After constructing these entity base types, the campaign generator attaches the CampaignInitialization to UpgradeCampaign (block 450). Further, when constructing the campaign upgrade procedure 460, the campaign generator constructs OutageInfo (block 461), AppAdd(block 462), BundleCreate (block 463), AddOnSu (block 464) and ImmCCB, ActivationUnit, SingleStepUpgrade, UpgradeMethod and UpgradeProcedure (block 465). The campaign generator subsequently attaches the UpgradeProcedure to UpgradeCampaign (block 466). Accordingly, a campaign file is generated.

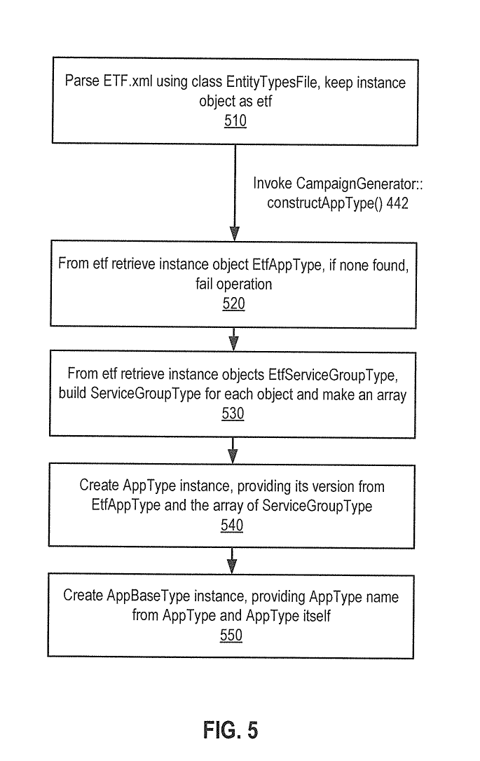

FIG. 5 illustrates an example of constructing the AppType of block 442, according to one embodiment. Initially, the campaign generator parses the ETF.xml file using the class EntityTypesFile and keeps the instance object as etf (block 510). When CampaignGenerator:: constructAppType( ) at block 442 is invoked, the campaign generator from etf retrieves the instance object EtfAppType (block 520). The operation fails if none is found. From etf the campaign generator retrieves the instance objects EtfServiceGroupType for the corresponding SGs, builds ServiceGroupType for each object and builds an array of the ServiceGroupType for the objects (block 530). The campaign generator creates the AppType instance, providing its version from EtfAppType and the array of ServiceGroupType (block 540). Then the campaign generator creates AppBaseType instance, providing AppType name from AppType and AppType itself (block 550).

The remove campaign generator does not need any input configuration. The remove campaign generator retrieves all of the application information from the target system and builds a remove campaign. The operation of the remove campaign generator is similar to the operation of the installation campaign generator; however, instead of generating a sequence of actions for adding campaign objects, the remove campaign generator generates a sequence of actions for removing objects from the target system.

As described above, field engineers do not need to have knowledge of the AMF and the SMF. In one embodiment, the following steps are performed by the field engineer.

(1) Prepare the target system's installation configuration file (e.g., campaign-config.xml): This file contains target system's information, such as the nodes on which the software application will be installed, how many instances will be installed on the nodes, how the nodes are grouped, which group matches which SU type. For this, the application designers can provide a template configuration file, which can simplify and reduce errors in the preparation of the configuration file. Since the ETF file is packaged in the application, the campaign generator can retrieve it from a known location; the field engineer will not need to re-build the ETF.

(2) Installation campaign generation: The field engineer installs the campaign generation framework, the software bundle containing an application, and the campaign generator on the target system. The field engineer provides an updated configuration file to the campaign generator. Using the previously created ETF and the updated configuration file, a campaign can be generated.

(3) Upgrade campaign generation: The campaign generator can fetch the software bundle's AMF model information from the target system and creates an upgrade campaign.

(4) Removing campaign generation: Removing campaign does not require any extra configurations. The campaign can be generated based on current software bundle's deployment models. For removing an application, the field engineer only needs to start the remove campaign generator, without any external input. Then the field engineer can use the generated remove campaign to remove the application when necessary.

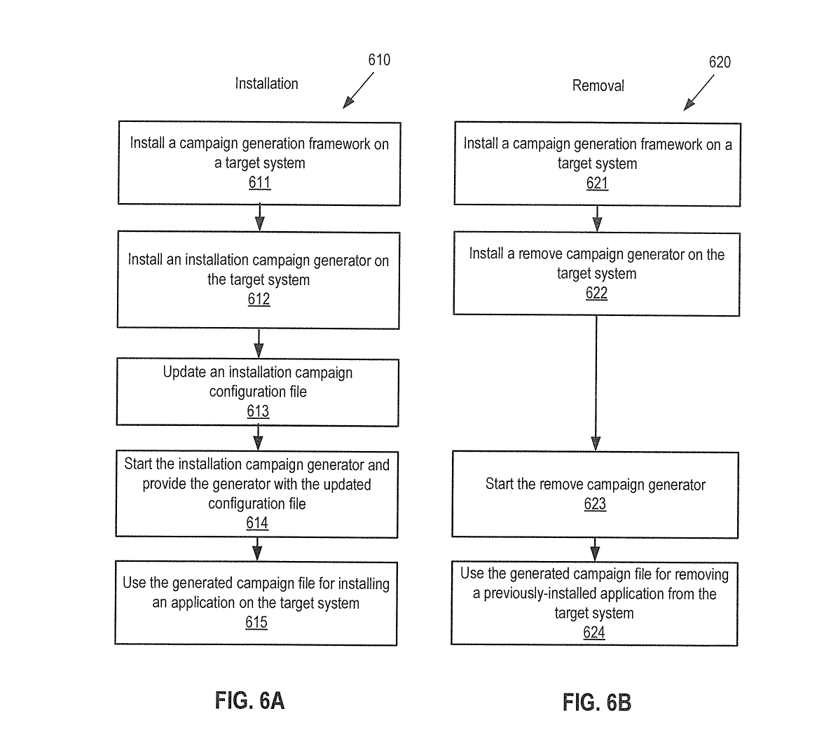

FIG. 6A is an example of an installation operation 610 performed on the target system at the direction of a field engineer, according to one embodiment of the invention. First, the campaign generation framework is installed on the target system (block 611). An installation campaign is installed on the target system (block 612). In one embodiment, the installation campaign generator is part of a software package that can be unpacked and installed on the target system. The field engineer then updates the installation campaign configuration file (i.e., the configuration file) (block 613), starts the install campaign generator and provides the install campaign generator with the updated configuration file (block 614). After the install campaign generator generates a campaign file, the field engineer can use the campaign file for installing an application on the target system (block 615). In one embodiment, the application may be a software bundle or may be a set of software programs stored in a software bundle.

FIG. 6B is an example of a remove operation 620 performed on the target system at the direction of a field engineer, according to one embodiment of the invention. First, the campaign generation framework is installed on the target system (block 621). A remove campaign generator is installed on the target system (block 622). In one embodiment, the remove campaign generator is part of a software package that can be unpacked and installed on the target system. Then the remove campaign generator can be started (block 623) to generate a remove campaign file. Then the field engineer can use the remove campaign file for removing a previously-installed application from the target system (block 624).

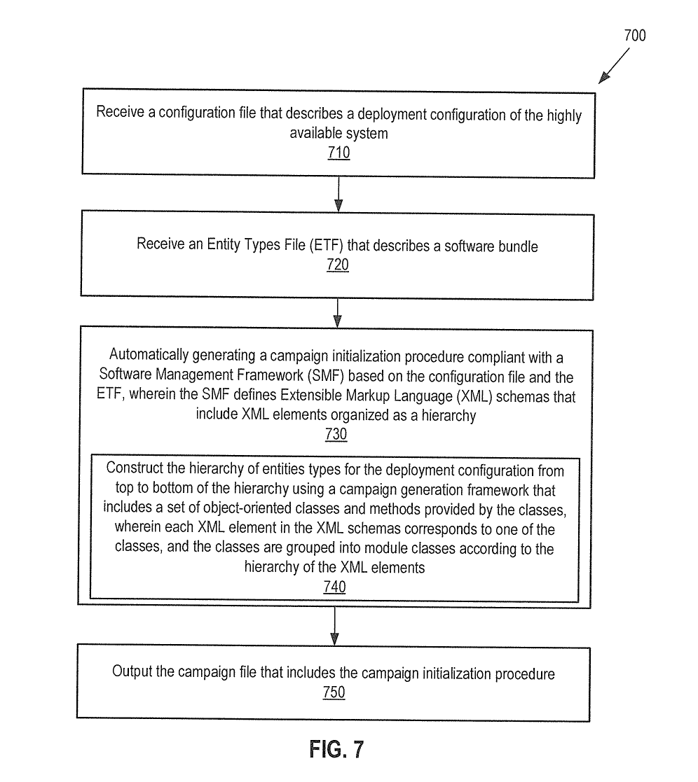

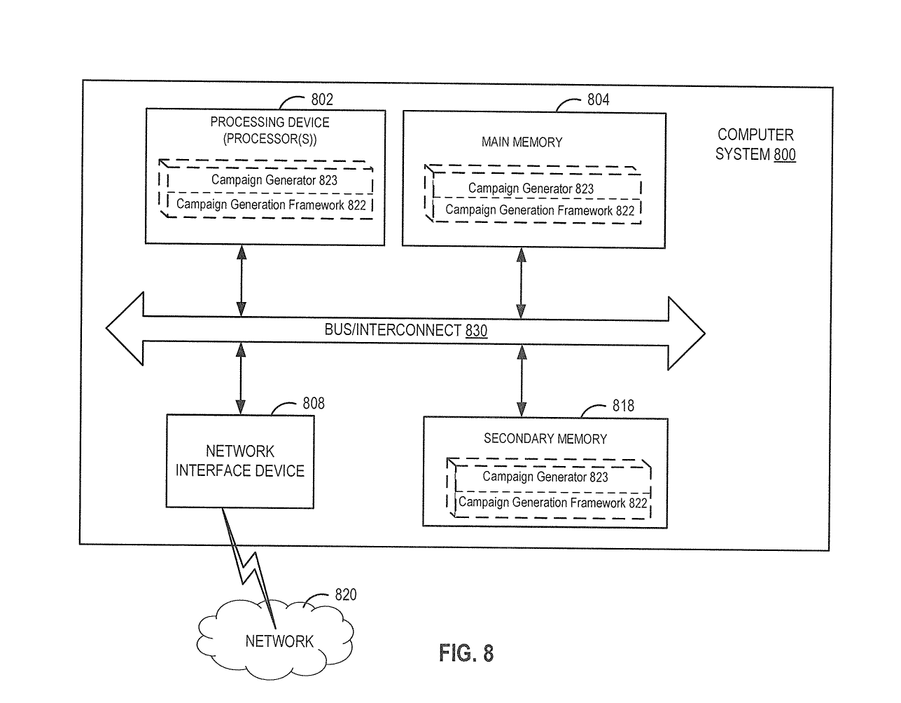

FIG. 7 illustrates a method 700 for generating a campaign file that describes actions for installing a software bundle on a highly available system, according to one embodiment of the invention. The method 700 may be performed by a computer system, such as a computer system 800 to be described below with reference to FIG. 8. One or more parts of an embodiment of the invention may be implemented using different combinations of software, firmware, and/or hardware.

In one embodiment, the method 700 begins with the computer system receiving a configuration file that describes a deployment configuration of the highly available system (block 710). The computer system also receives an ETF that describes the software bundle (block 720). Based on the configuration file and the ETF, the computer system automatically generates a campaign initialization procedure compliant with the SMF (block 730), where the SMF defines XML schemas that include XML elements organized as a hierarchy. To generate the campaign initialization procedure, the computer system constructs the hierarchy of entities types for the deployment configuration from top to bottom of the hierarchy, using a campaign generation framework that includes a set of object-oriented classes and methods provided by the classes (block 740). Each XML element in the XML schemas corresponds to one of the classes, and the classes are grouped into module classes according to the hierarchy of the XML elements. The computer system then outputs the campaign file that includes the campaign initialization procedure (block 750).

In one embodiment, the computer system also automatically generates an upgrade campaign procedure compliant with the SMF using the classes to describe the actions of adding entities instantiated from the entity types. In one embodiment, the computer system also automatically generates a remove campaign procedure compliant with the SMF using the classes to describe the actions of removing entities instantiated from the entity types.

FIG. 8 illustrates a diagrammatic representation of a machine in the exemplary form of a computer system 800 within which a set of instructions, for causing the machine to perform any one or more of the methodologies discussed herein, may be executed. The computer system 800 may be a server computer, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The computer system 800 includes a processing device 802. The processing device 802 represents one or more general-purpose processors, each of which can be: a microprocessor, a central processing unit (CPU), a multicore system, or the like. More particularly, the processing device 802 may be a complex instruction set computing (CISC) microprocessor, reduced instruction set computing (RISC) microprocessor, very long instruction word (VLIW) microprocessor, processor implementing other instruction sets, or processors implementing a combination of instruction sets. The processing device 802 may also be one or more special-purpose processing devices such as an application specific integrated circuit (ASIC), a field programmable gate array (FPGA), a digital signal processor (DSP), network processor, or the like. In one embodiment, the processing device 802 is adapted to execute the operations of a campaign generator 823 using a campaign generation framework 822 as described above.

In one embodiment, the processor device 802 is coupled to one or more memory devices such as: a main memory 804 (e.g., read-only memory (ROM), flash memory, dynamic random access memory (DRAM) such as synchronous DRAM (SDRAM) or Rambus DRAM (RDRAM), etc.), a secondary memory 818 (e.g., a magnetic data storage device, an optical magnetic data storage device, etc.), and other forms of computer-readable media, which communicate with each other via a bus or interconnect 830. The memory devices may also different forms of read-only memories (ROMs), different forms of random access memories (RAMs), static random access memory (SRAM), or any type of media suitable for storing electronic instructions. In one embodiment, the memory devices may store the code and data of the campaign generator 823 and/or the campaign generation framework 822.

The computer system 800 may further include a network interface device 808. A part or all of the data and code of the campaign generator 823 and/or the campaign generation framework 822 may be transmitted or received over a network 820 via the network interface device 808. Although not shown in FIG. 8, the computer system 800 also may include user input/output devices (e.g., a keyboard, a touchscreen, speakers, and/or a display).

In one embodiment, the campaign generator 823 and/or the campaign generation framework 822 can be implemented using code and data stored and executed on one or more computer systems (e.g., the computer system 800). Such computer systems store and transmit (internally and/or with other electronic devices over a network) code (composed of software instructions) and data using computer-readable media, such as non-transitory tangible computer-readable media (e.g., computer-readable storage media such as magnetic disks; optical disks; read only memory; flash memory devices as shown in FIGS. 8 as 804 and 818) and transitory computer-readable transmission media (e.g., electrical, optical, acoustical or other form of propagated signals—such as carrier waves, infrared signals). A non-transitory computer-readable medium of a given computer system typically stores instructions for execution on one or more processors of that computer system. One or more parts of an embodiment of the invention may be implemented using different combinations of software, firmware, and/or hardware.

The operations of the method of FIGS. 4-7 have been described with reference to the exemplary embodiment of FIG. 8. However, it should be understood that the operations of the methods of FIGS. 4-7 can be performed by embodiments of the invention other than those discussed with reference to FIG. 8, and the embodiment discussed with reference to FIG. 8 can perform operations different from those discussed with reference to the methods of FIGS. 4-7. While the methods of FIGS. 4-7 show a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A method performed by a computer system for generating a campaign file that describes actions for installing a software bundle on a highly available system, the method comprising:
receiving a configuration file that describes a deployment configuration of the highly available system;
receiving an entity types file (ETF) that describes the software bundle;
automatically generating, by the computer system, a campaign initialization procedure compliant with a Software Management Framework (SMF) based on the configuration file and the ETF, wherein the SMF defines Extensible Markup Language (XML) schemas that include XML elements organized as a hierarchy, and wherein the automatically generating further comprises:
constructing the hierarchy of entities types for the deployment configuration from top to bottom of the hierarchy using a campaign generation framework that includes a set of object-oriented classes and methods provided by the classes, wherein each XML element in the XML schemas corresponds to one of the classes, and the classes are grouped into module classes according to the hierarchy of the XML elements; and
outputting the campaign file that includes the campaign initialization procedure.

2. The method of claim 1, further comprising: automatically generating a campaign upgrade procedure compliant with the SMF using the classes to describe the actions of adding entities instantiated from the entity types.

3. The method of claim 1, further comprising: automatically generating a campaign remove procedure compliant with the SMF using the classes to describe the actions of removing entities instantiated from the entity types.

4. The method of claim 1, wherein automatically generating further comprises:
invoking an instance of a parent class of the classes to construct a parent XML element object for the campaign file; and
invoking children classes of the parent class to construct children XML element objects for the campaign file, wherein the children XML element objects are attached to the parent XML element object and are retrievable from the parent XML element object.

5. The method of claim 1, wherein the deployment configuration specifies target nodes for installation of the software bundle and grouping of the target nodes.

6. The method of claim 1, wherein the hierarchy of entities types includes an application type at a first level, and a component type at a second level lower than the first level.

7. The method of claim 1, wherein each class that has a corresponding XML element receives one or more attributes of the corresponding XML element and constructs an object for the corresponding XML element.

8. The method of claim 1, wherein the campaign file is an XML file compliant with the SMF.

9. The method of claim 1, wherein the classes are constructed using a Python programming language.

10. The method of claim 1, wherein the classes includes a first set of module classes compliant with the Upgrade Campaign Specification (UCS) and a second set of module classes corresponding to the ETF.

11. A computer system adapted to generate a campaign file that describes actions for installing a software bundle on a highly available system, the computer system comprising:
one or more processors;
one or more memory devices coupled to the one or more processors; and
a configuration generator coupled to the one or more processors and the one or more memory devices, the configuration generator adapted to:
receive a configuration file that describes a deployment configuration of the highly available system;
receive an entity types file (ETF) that describes the software bundle;
automatically generate a campaign initialization procedure compliant with a Software Management Framework (SMF) based on the configuration file and the ETF, wherein the SMF defines Extensible Markup Language (XML) schemas that include XML elements organized as a hierarchy, and
output the campaign file that includes the campaign initialization procedure,
wherein the configuration generator, when automatically generating the campaign initialization procedure, is further adapted to construct the hierarchy of entities types for the deployment configuration from top to bottom of the hierarchy using a campaign generation framework that includes a set of object-oriented classes and methods provided by the classes, wherein each XML element in the XML schemas corresponds to one of the classes, and the classes are grouped into module classes according to the hierarchy of the XML elements.

12. The computer system of claim 11, wherein the configuration generator is further adapted to automatically generate a campaign upgrade procedure compliant with the SMF using the classes to describe the actions of adding entities instantiated from the entity types.

13. The computer system of claim 11, wherein the configuration generator is further adapted to automatically generate a campaign remove procedure compliant with the SMF using the classes to describe the actions of removing entities instantiated from the entity types.

14. The computer system of claim 11, wherein the configuration generator, when automatically generating the campaign initialization procedure, is further adapted to:
invoke an instance of a parent class of the classes to construct a parent XML element object for the campaign file; and
invoke children classes of the parent class to construct children XML element objects for the campaign file, wherein the children XML element objects are attached to the parent XML element object and are retrievable from the parent XML element object.

15. The computer system of claim 11, wherein the deployment configuration specifies target nodes for installation of the software bundle and grouping of the target nodes.

16. The computer system of claim 11, wherein the hierarchy of entities types includes an application type at a first level, and a component type at a second level lower than the first level.

17. The method of claim 11, wherein each class that has a corresponding XML element receives one or more attributes of the corresponding XML element and constructs an object for the corresponding XML element.

18. The computer system of claim 11, wherein the campaign file is an XML file compliant with the SMF.

19. The computer system of claim 11, wherein the classes are constructed using a Python programming language.

20. The computer system of claim 11, wherein the classes includes a first set of module classes compliant with the Upgrade Campaign Specification (UCS) and a second set of module classes corresponding to the ETF.
